(19) United States
(12) Patent Application Publication
(10) Pub. No.: US 2012/0240090 A1
(43) Pub. Date: Sep. 20, 2012

(54) CLOCK TREE DESIGNING APPARATUS AND CLOCK TREE DESIGNING METHOD

(75) Inventors: Toshiaki SHIRAI, Tokyo (JP); Takashi ISHIOKA, Kanagawa (JP)

(73) Assignee: KABUSHIKI KAISHA TOSHIBA, Tokyo (JP)

(21) Appl. No.: 13/224,186

(22) Filed: Sep. 1, 2011

(30) Foreign Application Priority Data
Mar. 17, 2011 (JP) 2011-059454

(51) Int. Cl. G06F 17/50

(52) U.S. Cl. 716/113

(57) ABSTRACT

A clock tree designing apparatus in an embodiment includes: an equidistant point set calculation section configured to set a path setting block area in which a path length of a clock path takes a shortest Manhattan distance and determine a set of equidistant points between a target sink and a farthest sink; a branch point setting section configured to set, as a branch point, a point in the set of equidistant points that is farthest from a clock source within the path setting block area; and a path setting section configured to set a shared path for the target sink and the farthest sink within the path setting block area from the clock source to the branch point, and to set a clock path from the branch point to the target sink or the farthest sink.

### CROSS-REFERENCE TO RELATED APPLICATION

This application is based upon and claims the benefit of priority from the prior Japanese Patent Application No. 2011-59454, filed on Mar. 17, 2011; the entire contents of which are incorporated herein by reference.

### FIELD

Embodiments described herein relate generally to a clock tree designing apparatus and a clock tree designing method.

### BACKGROUND

A clock tree scheme is one of conventional clock distribution schemes in LSI. Designing a layout of a clock tree needs to take into account factors such as clock latency, the number of buffers, and clock skew.

An H tree scheme involves setting a clock path (which may be simply referred to as a path hereinafter) at the centroid between sinks to which a clock is supplied. The H tree scheme is superior from the viewpoint of the reduction in the number of buffers and the reduction in OCV (on-chip variation) margin because many shared paths are used as part of paths to sinks. The H tree scheme is also superior from the viewpoint of the clock skew because the path lengths of paths to sinks are often equal.

From the viewpoint of the clock latency, it is preferable that the path length of a clock path from a clock source to a sink farthest from the clock source (hereinafter referred to as a farthest sink) be short. However, in the H tree scheme, a clock path is always designed to pass through the centroid between two sinks. This may result in a relatively large clock latency.

A possible method for clock tree design that minimizes the clock latency is to set the clock path between the clock source and the farthest sink only under the condition that the distance from the clock source to the farthest sink should be a Manhattan distance.

However, in the above method, it is difficult to optimize paths between the clock source and sinks other than the farthest sink. This may lead to increases in the number of buffers, the OCV margin, and the skew.

### BRIEF DESCRIPTION OF THE DRAWINGS

FIG. 1 is a block diagram showing a clock tree designing apparatus according to a first embodiment of the present invention;

FIGS. 2A to 2F are illustrative diagrams showing relationships of a clock tree with clock latency, the number of buffers, and clock skew;

FIGS. 3A and 3B are illustrative diagrams showing relationships of a clock tree with clock latency, the number of buffers, and clock skew;

FIG. 4 is an illustrative diagram for describing a clock tree designing method in the first embodiment;

FIG. 5 is an illustrative diagram for describing the clock tree designing method in the first embodiment;

FIG. 6 is an illustrative diagram for describing the clock tree designing method in the first embodiment;

FIG. 7 is an illustrative diagram for describing the clock tree designing method in the first embodiment;

FIG. 8 is an illustrative diagram for describing the clock tree designing method in the first embodiment;

FIG. 9 is an illustrative diagram for describing the clock tree designing method in the first embodiment;

FIG. 10 is an illustrative diagram for describing the clock tree designing method in the first embodiment;

FIG. 11 is an illustrative diagram for describing how to determine a trace of equidistant points;

FIG. 12 is an illustrative diagram for describing how to determine the trace of equidistant points;

FIG. 13 is an illustrative diagram for describing how to determine the trace of equidistant points;

FIG. 14 is an illustrative diagram for describing how to determine the trace of equidistant points;

FIG. 15 is an illustrative diagram for describing how to determine the trace of equidistant points;

FIG. 16 is an illustrative diagram for describing how to determine the trace of equidistant points;

FIG. 17 is an illustrative diagram for describing how to determine the trace of equidistant points;

FIG. 18 is an illustrative diagram for describing the clock tree designing method in the first embodiment;

FIG. 19 is an illustrative diagram for describing the clock tree designing method in the first embodiment;

FIG. 20 is an illustrative diagram for describing the clock tree designing method in the first embodiment;

FIG. 21 is an illustrative diagram for describing the clock tree designing method in the first embodiment;

FIG. 22 is an illustrative diagram for describing the clock tree designing method in the first embodiment;

FIG. 23 is an illustrative diagram for describing the clock tree designing method in the first embodiment;

FIG. 24 is an illustrative diagram for describing the clock tree designing method in the first embodiment;

FIG. 25 is a flowchart showing overall operation of designing a clock tree;

FIG. 26 is a flowchart showing a flow of setting a branch point and paths in FIG. 25;

FIG. 27 is an illustrative diagram showing a second embodiment of the present invention;

FIG. 28 is an illustrative diagram showing the second embodiment of the present invention; and

FIG. 29 is a flowchart showing the second embodiment of the present invention.

### DETAILED DESCRIPTION

A clock tree designing apparatus in an embodiment includes: an equidistant point set calculation module configured to determine a set of equidistant points at which a Manhattan distance from a target sink sequentially selected from a group of sinks for which clock latency is to be matched and a Manhattan distance from a farthest sink in the group of sinks located farthest from a clock source are equal; a path setting block setting module configured to set a path setting block area in which a clock path is potentially formed and a path length of the clock path takes a shortest Manhattan distance; a branch point setting module configured to set, as a branch point, a point in the set of equidistant points that is farthest from the clock source within the path setting block area; and a path setting module configured to set a shared path for the target sink and the farthest sink within the path setting block area from the clock source to the branch point, and to set a clock path from the branch point to the target sink and a clock path from the branch point to the farthest sink so that a path length takes a shortest Manhattan distance.

Embodiments of the present invention will be described in detail below with reference to the drawings.

### First Embodiment

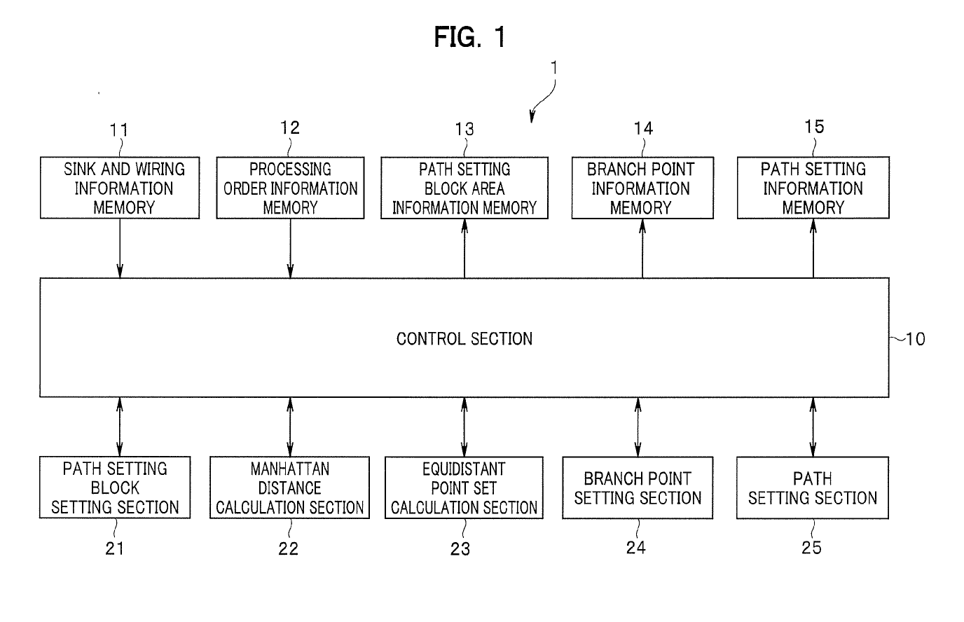

FIG. 1 is a block diagram showing a clock tree designing apparatus according to a first embodiment of the present invention.

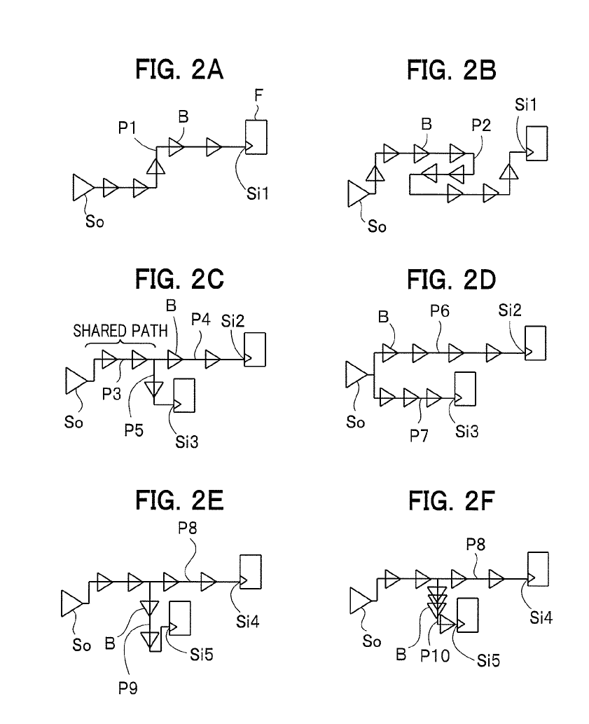

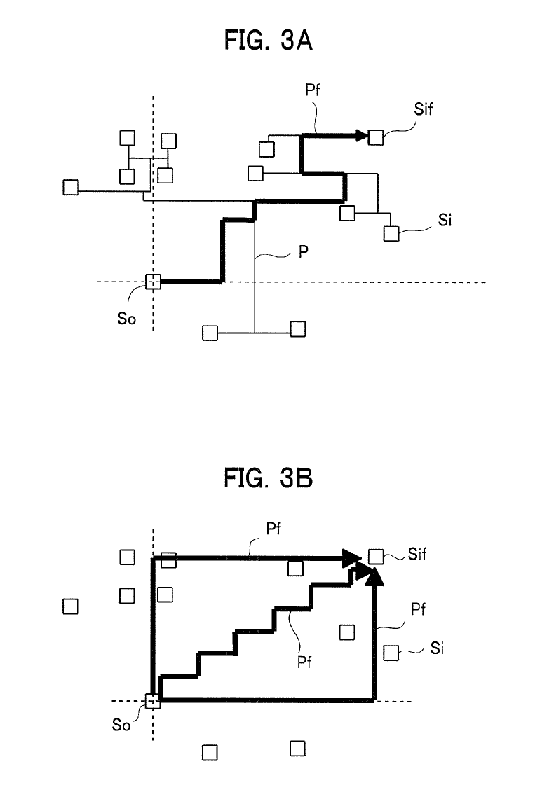

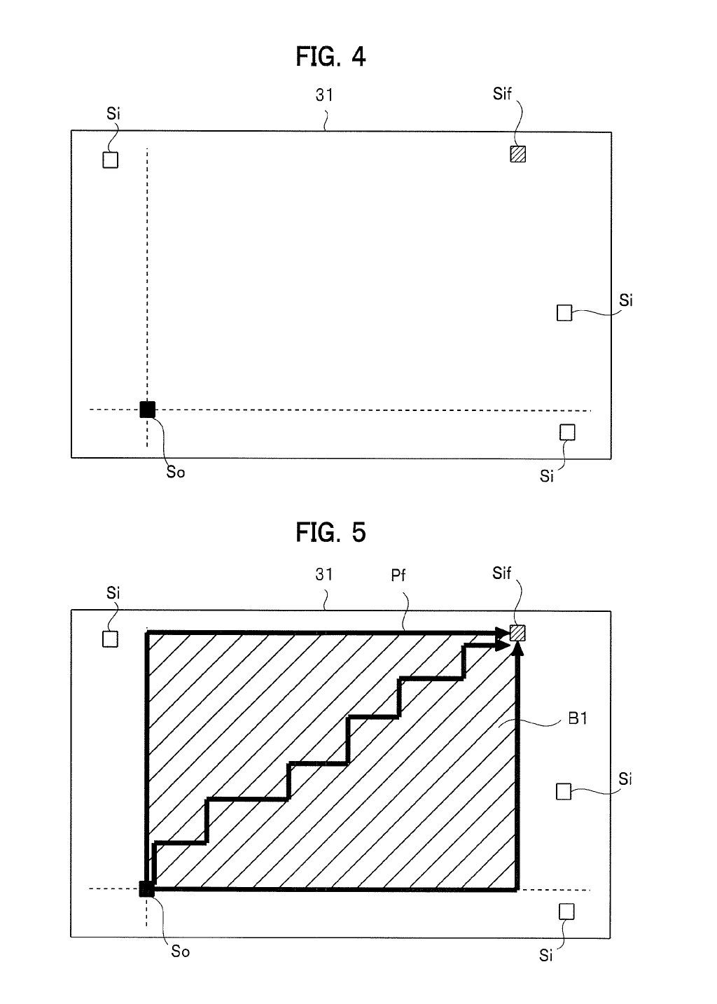

First, a clock tree designing method in the present embodiment will be described with reference to FIGS. 2A to 2F and FIGS. 3A and 3B. FIGS. 2A to 2F and FIGS. 3A and 3B are illustrative diagrams showing relationships of a clock tree with clock latency, the number of buffers, and clock skew. In FIGS. 2A to 2F, a signal pin of a flip-flop F to which a clock is supplied is considered as a sink.

FIGS. 2A and 2B show relationships between the clock latency and paths. In FIGS. 2A and 2B, clock paths P1 and P2 are shown to be set between a clock source So and a sink Si1, respectively. The path length of the path P1 is equal to a Manhattan distance, whereas the path length of the path P2 is longer than the Manhattan distance because the path P2 has parallel portions. From the viewpoint of the clock latency, it is preferable that the path length of a path to the farthest sink is shorter as in FIG. 2A.

FIGS. 2C and 2D show relationships between the number of buffers and the OCV margin, and paths. In FIGS. 2C and 2D, clock paths P3 to P7 are shown to be set between the clock source So and sinks Si2 and Si3. In FIG. 2C, among the paths P3 to P5 from the clock source So to the sinks Si2 and Si3, the path P3 is a shared path. In FIG. 2D, the paths P6 and P7 from the clock source So to the sinks Si2 and Si3 are independent paths with no shared path. From the viewpoint of the number of buffers and the OCV margin, it is preferable to provide a shared path as in FIG. 2C.

FIGS. 2E and 2F show relationships between the clock skew and paths. In FIGS. 2E and 2F, clock paths P8 to P10 are shown to be set between the clock source So and sinks Si4 and Si5. Examples illustrated in FIGS. 2E and 2F have no clock skew. The occurrence of clock skew is avoided in FIG. 2E by making the path lengths of the paths P8 and P9 equal, whereas the occurrence of clock skew is avoided in FIG. 2F by providing more buffers on the path P10 than buffers on the path P8.

If the approach of inserting buffers in order to reduce the clock skew is employed, delay variations and a decrease in the power-supply voltage may affect the clock tree in a fine process. As a result, inserting the buffers may contrarily increase the skew under certain chip conditions. Therefore, from the viewpoint of the clock skew, it is preferable that the distance to each sink is equal as in FIG. 2E.

Thus, from the viewpoint of the clock latency, it is preferable that the path length of the path to the farthest sink be short. From the viewpoint of the number of buffers and the OCV margin, it is preferable to set a long shared path. From the viewpoint of the clock skew, it is preferable that the distance to each sink be equal.

In FIGS. 3A and 3B, sinks Si are indicated by square frames, and a path between the clock source So and a farthest sink Sif is indicated by a bold line. FIG. 3A illustrates the H tree scheme, in which paths P are indicated by lines that connect the sinks Si. Since each path P is designed to pass through the centroid between two sinks, a path Pf to the farthest sink Sif has parallel portions formed therein, resulting in a path length longer than the Manhattan distance. That is, the H tree scheme has a drawback in that the path length to the farthest sink may be long, which causes a large clock latency.

FIG. 3B illustrates an example in which the path from the clock source So to the farthest sink Sif is set to have a path length of the Manhattan distance. Any path may be employed to minimize the path length to the farthest sink Sif, as long as the path passes within a bold square frame and has no parallel portions formed therein.

However, the approach in FIG. 3B cannot optimize paths to the other sinks and therefore disadvantageous from the viewpoints such as of the number of buffers and the clock skew.

Therefore, the present embodiment employs a clock tree designing method shown in FIGS. 4 to 24. With this method, while the clock latency is minimized, the length of a shared path between sinks is increased and the path lengths between the sinks are equalized. This enables the generation of a clock tree that optimizes the clock latency, the number of buffers, the clock skew, and the OCV margin.

In the present embodiment, in order to minimize the clock latency, path determination puts priority on the path to the farthest sink Sif. Also, in order to increase the length of a shared path, the shared path is used up to a position as far as possible from the clock source and sets the end of the shared path as a branch point to form paths from the branch point to respective sinks. The position of the branch point is determined so that the paths from the branch point to the respective sinks are set to have the same length.

FIG. 4 shows an example of a circuit layout for which a clock tree is to be designed. FIGS. 5 to 24 show the same circuit layout as FIG. 4. In FIGS. 4 to 24, a solid square frame indicates a clock source, open square frames indicate sinks to which it is desired for the clock (to match the clock latency) to be simultaneously supplied in the circuit layout, and a shaded square frame indicates a farthest sink. Dashed lines in FIGS. 4 to 24 indicate directions of a wiring pattern in which wiring is capable on the circuit. Examples in FIGS. 4 to 24 illustrate that the wiring pattern can be horizontally and vertically formed at a predetermined wiring pitch. In FIGS. 4 to 24, determined paths are indicated by bold lines.

First, in order to minimize the clock latency, path candidates that provide the shortest path length (i.e., the Manhattan distance) of the path between the clock source So and the farthest sink Sif are determined A number of paths provide the Manhattan distance as the path length between the clock source So and the farthest sink Sif. Among such paths, FIG. 5 indicates three paths Pf with bold lines. That is, in an area (a shaded portion) B1 surrounded by a rectangle with diagonal vertexes located at the clock source So and the farthest sink Sif, the paths may be set so that no parallel portions are formed. Thus, the area of the shaded portion is an area in which the path lengths of potential paths between two points can be set to the Manhattan distance (hereinafter referred to as a path setting block area).

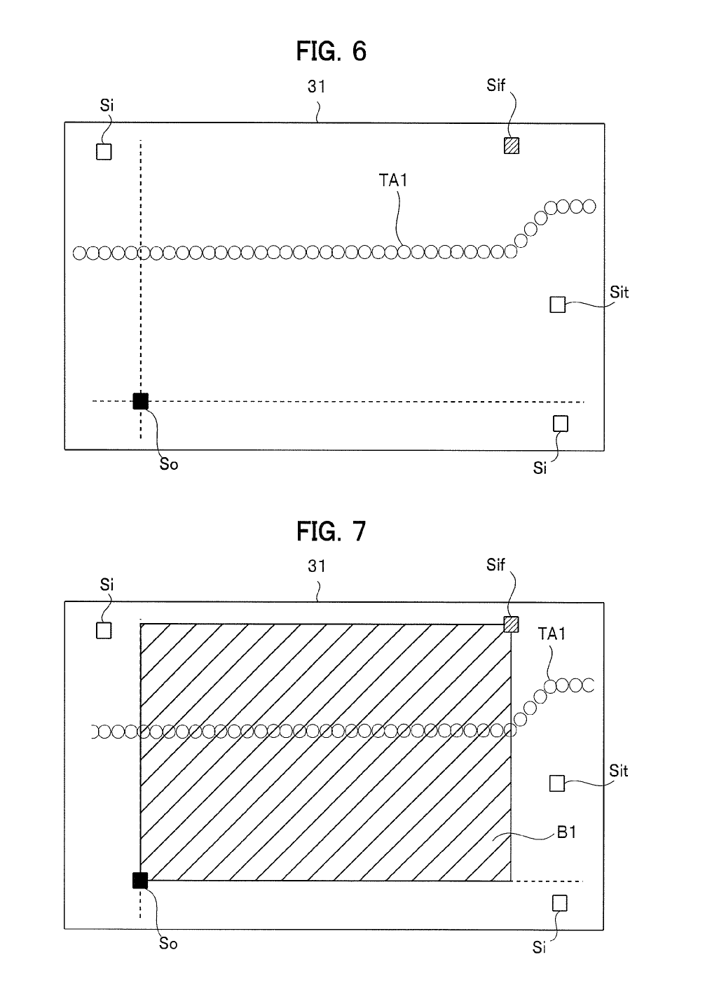

Now, for example, as shown in FIG. 6, one sink is taken as a target sink Sit for which a path is to be set. A trace TA1 of points at which the Manhattan distance from the farthest sink Sif and the Manhattan distance from the target sink Sit are equal is determined In FIG. 6 and subsequent figures, these points are indicated by open circles. Part of the trace TA1 is within the path setting block area B1, as shown in FIG. 7.

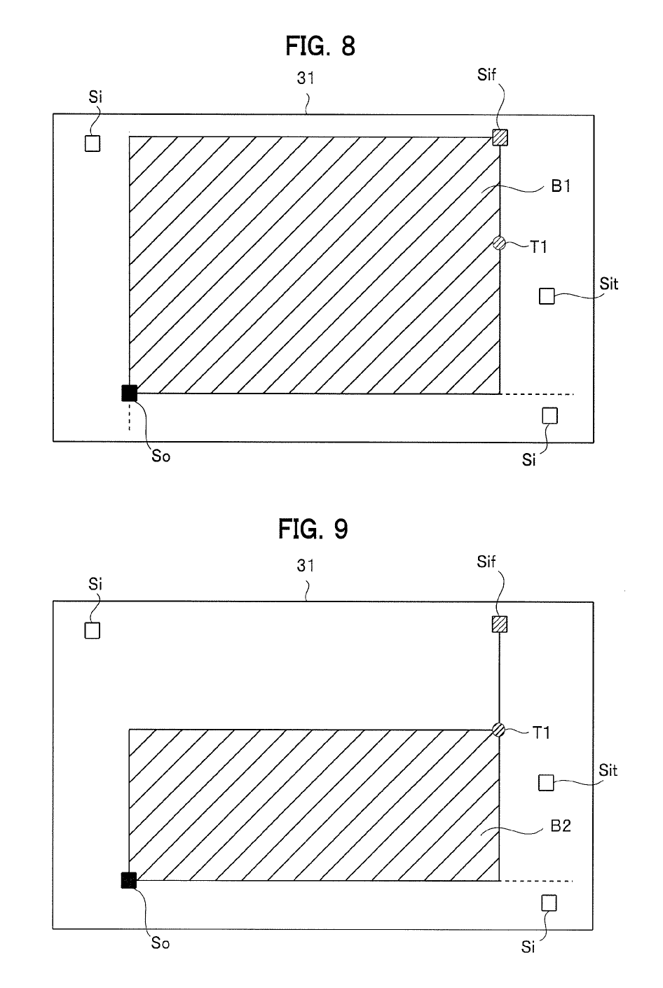

In the present embodiment, as shown in FIG. 8, on the trace TA1 of the equidistant points, a point (a shaded point) farthest from the clock source So within the path setting block area B1 is set as a branch point T1. In the present embodiment, the branch point T1 is a point at which a path from the clock source So to the farthest sink Sif and a path from the clock source So to the target sink Sit branch apart. A path from the clock source So to the branch point T1 is a shared path for the farthest sink Sif and the target sink Sit. Candidates for the shared path from the clock source So to the branch point T1 are set within a path setting block area B2 indicated by a shaded portion in FIG. 9. This allows the path length of the path from the clock source So to the branch point T1 to be the Manhattan distance defined by a rectangle with diagonal vertexes located at the clock source So and the branch point T1, thereby minimizing the path length of the path from the clock source So to the branch point T1.

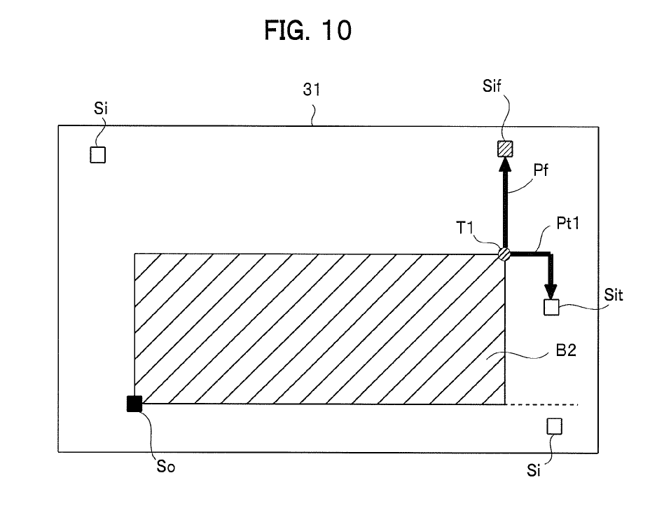

As shown in FIG. 10, a path Pf from the branch point T1 to the farthest sink Sif, and a path Pt1 from the branch point T1 to the target sink Sit are determined The path lengths of the paths Pf and Pt1 are set to the Manhattan distance, so that the path lengths of the paths Pf and Pt1 are the shortest and equal. In addition, the shared path is used from the clock source So to the branch point T1. Therefore, the path from the clock source So to the farthest sink Sif and the path from the clock source So to the target sink Sit are the shortest and equal in length, and have the longest shared path.

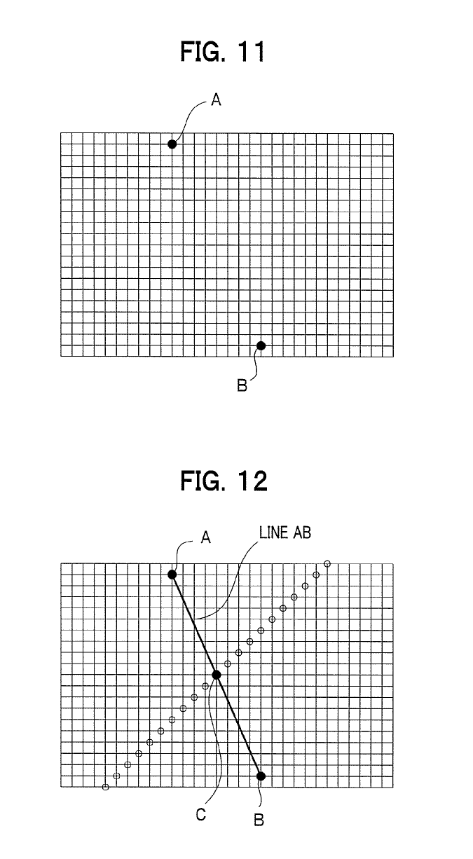

FIGS. 11 to 17 are illustrative diagrams for describing how to determine the trace of the points at which the Manhattan distance from the farthest sink Sif and the Manhattan distance from the target sink Sit are equal.

A mesh in FIG. 11 represents a wiring grid. Solid circles on the grid in FIG. 11 indicate positions A and B of two sinks for which a trace of equidistant points is to be determined. First, as shown in FIG. 12, a grid point at a position C (a solid circle) of the midpoint between the positions A and B is determined If an odd number of grid blocks are present between the two points A and B horizontally and/or vertically, the position C of the midpoint is not located on a grid point. In this case, for example, the position C of the midpoint may be moved by a half grid block to locate the point C of the midpoint on a grid point. Other approaches may also be used, such as setting the positions of the sinks in advance so that an even number of grid blocks are present between the sinks.

Next, the wiring grid is considered as an orthogonal coordinate system with the origin located at the grid point of the midpoint C. In quadrants through which a segment AB does not pass, points (hereinafter referred to as temporary midpoints) indicated by open circles are positioned on the grid so that the position of the points changes in both the x-direction and the y-direction from the grid point of the midpoint C. The temporary midpoints are used for determining points at which the distances from the points A and B are equal (the Manhattan distance). The distance of each temporary midpoint from each of the points A and B increases in the y-direction as the distance decreases in the x-direction, and the distance decreases in the y-direction as the distance increases in the x-direction.

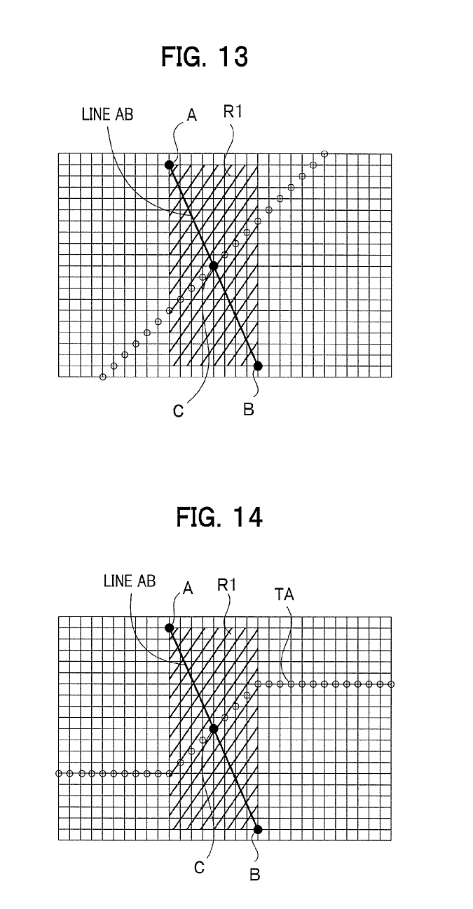

However, as shown in FIG. 13, temporary midpoints positioned outside a rectangular area R1 with vertexes located at the points A and B have different Manhattan distances from the points A and B, respectively. Midpoints with the equal Manhattan distance from the points A and B exist on a grid line extended in the x-direction or the y-direction from temporary midpoints on edges of the area R1.

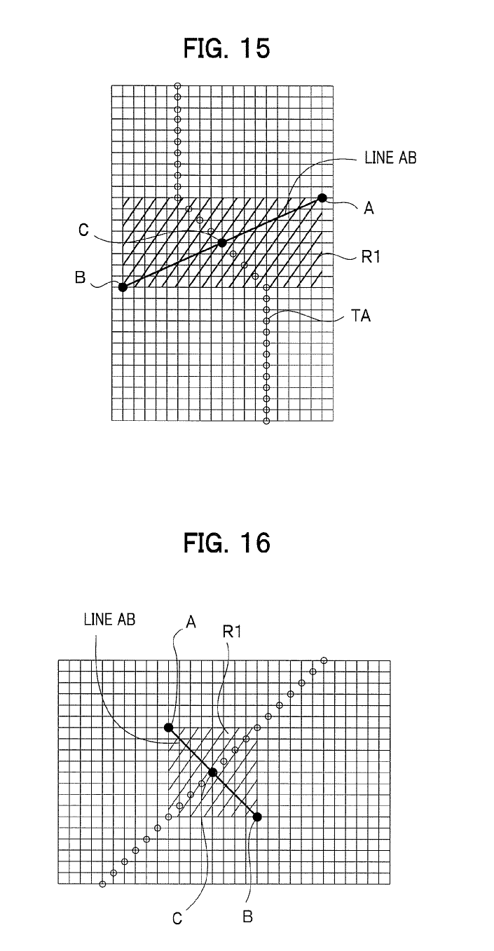

FIG. 14 shows a trace TA of the equidistant points determined in the above manner. Whether the midpoints exist on a grid line extended in the x-direction or on a grid line extended in the y-direction depends on the size of the area R1 in the x-direction and the y-direction. As in FIG. 14, if the size of the area R1 in the y-direction is larger than the size in the x-direction, the midpoints exist in the x-direction. As shown in FIG. 15, if the size of the area R1 in the y-direction is smaller than the size in the x-direction, the midpoints exist in the y-direction.

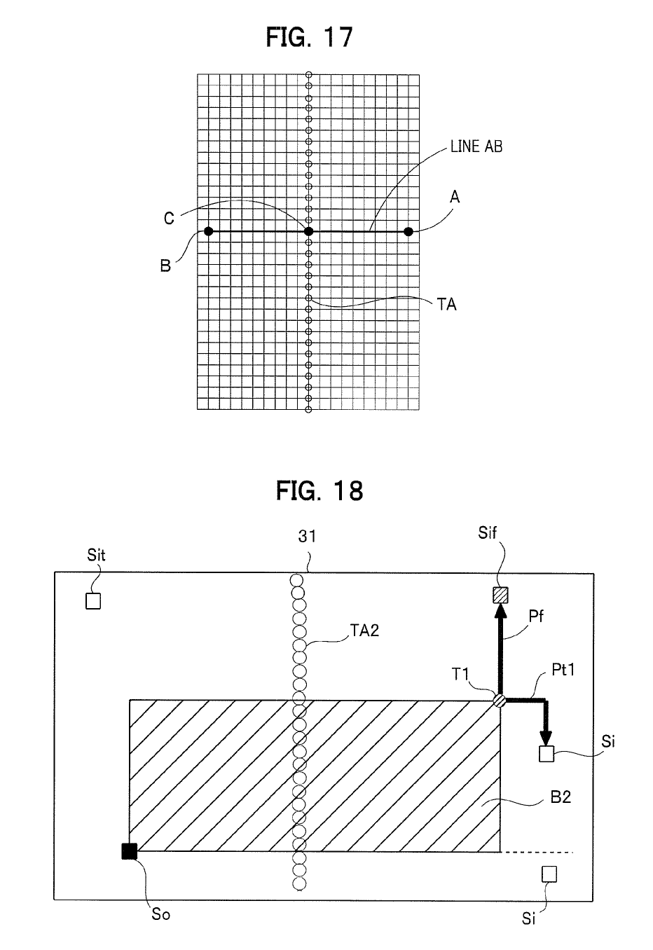

As shown in FIG. 16, if the area R1 has the same size in the x-direction and the y-direction, the temporary midpoints directly serve as the midpoints. As shown in FIG. 17, if one of the x-coordinate and the y-coordinate of the two points A and B is the same, grid points on a perpendicular bisector of the line AB correspond to the trace of the equidistant points.

In a similar manner, a path to each sink is continuously determined

For example, as shown in FIG. 18, one sink is taken as the target sink Sit for which a path is to be set. A trace TA2 of points with equal Manhattan distances is determined between the farthest sink Sif and the target sink Sit. Part of the trace TA2 is within a path setting block area B2, as shown in FIG. 18.

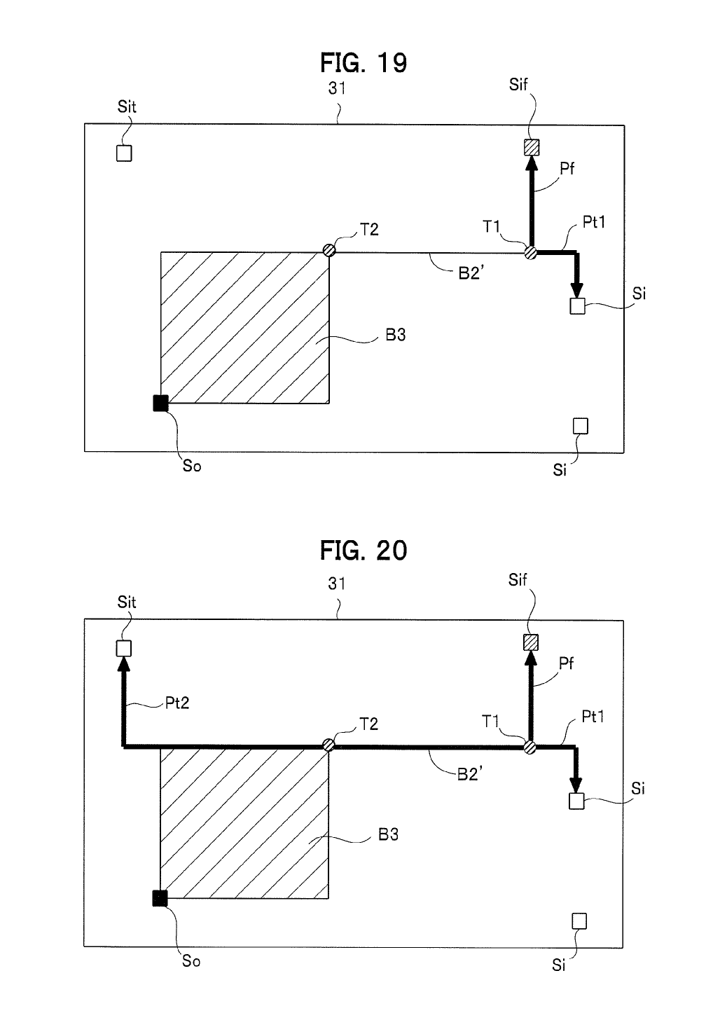

Next, as shown in FIG. 19, on the trace TA2 of the equidistant points, a point (a shaded point) farthest from the clock source So within the path setting block area B2 is set as a branch point T2. The branch point T2 is a point at which the path from the clock source So to the farthest sink Sif and a path from the clock source So to the target sink Sit branch apart. A path from the clock source So to the branch point T2 is a shared path for the farthest sink Sif and the target sink Sit. Candidates for the shared path from the clock source So to the branch point T2 are set within a path setting block area B3 indicated by a shaded portion in FIG. 19. This allows the path length of the path from the clock source So to the branch point T2 to be minimized

As shown in FIG. 20, a path Pt2 from the branch point T2 to the target sink Sit is determined so that the path length is the Manhattan distance. The path between the branch point T2 and the branch point T1 is set within a partial area B2′ in the path setting block area B2, as shown in FIG. 20.

The path lengths of the paths from the branch point T2 to the farthest sink Sif and to the target sink Sit are set to the Manhattan distance, so that the path lengths of the paths are the shortest and equal. In addition, the shared path is used from the clock source So to the branch point T2. Therefore, the path from the clock source So and the farthest sink Sif and the path from the clock source So to the target sink Sit are the shortest and equal in length, and have the longest the shared path.

Similarly, a path to a next set target sink Sit is determined

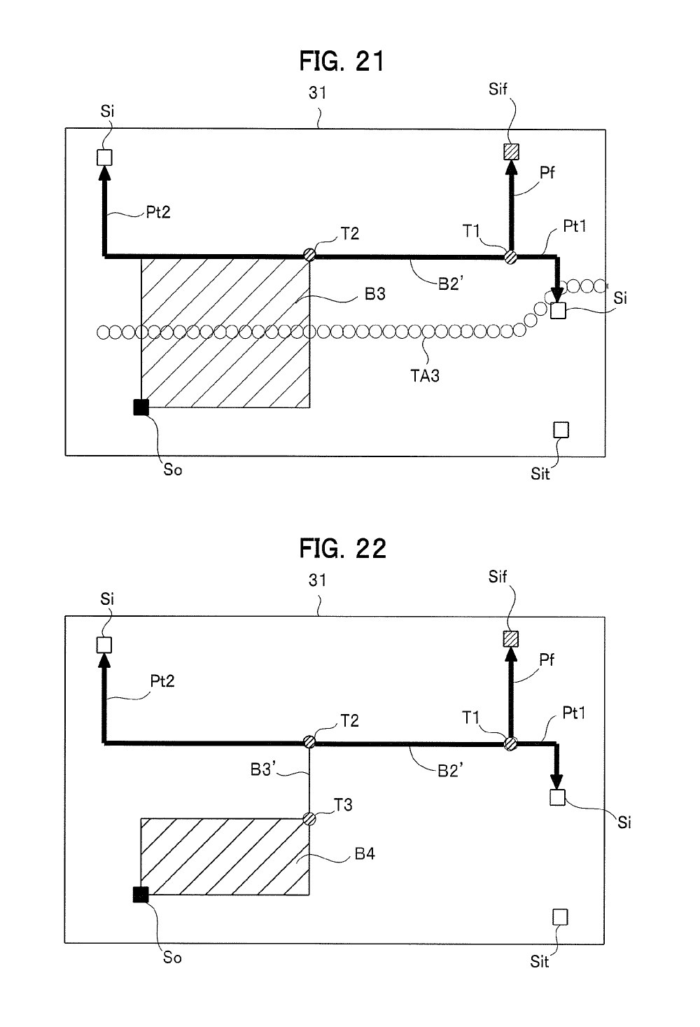

As shown in FIG. 21, one of the remaining sinks is taken as the target sink Sit for which a path is to be set. A trace TA3 of points with equal Manhattan distances is determined between the farthest sink Sif and the target sink Sit. Part of the trace TA3 is within a path setting block area B3, as shown in FIG. 21.

Next, as shown in FIG. 22, on the trace TA3 of the equidistant points, a point (a shaded point) farthest from the clock source So within the path setting block area B3 is set as a branch point T3. The branch point T3 is a point at which the path from the clock source So to the farthest sink Sif and a path from the clock source So to the target sink Sit branch apart. A path from the clock source So to the branch point T3 is a shared path for the farthest sink Sif and the target sink Sit. Candidates for the shared path from the clock source So to the branch point T3 are set in a path setting block area B4 indicated by a shaded portion in FIG. 22. This allows the path length of the path from the clock source So to the branch point T3 to be minimized

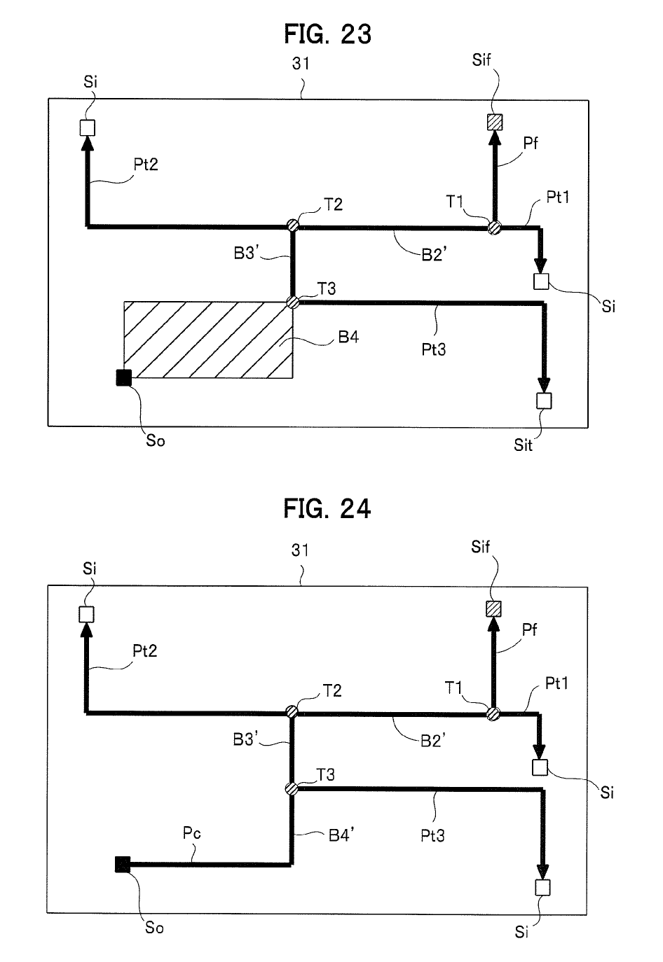

As shown in FIG. 23, a path Pt3 from the branch point T3 to the target sink Sit is determined so that the path length is the Manhattan distance. The path between the branch point T3 and the branch point T2 is set within a partial area B3′ in the path setting block area B3, as shown in FIG. 23.

The path length of the paths from the branch point T3 to the farthest sink Sif and to the target sink Sit are set to the Manhattan distance, so that the path lengths of the paths are the shortest and equal. In addition, the shared path is used from the clock source So to the branch point T3. Therefore, the path from the clock source So and the farthest sink Sif and the path from the clock source So to the target sink Sit are the shortest and equal in length, and have the longest shared path.

Finally, a path from the clock source So to the branch point T3 is set within a path setting block area B4 so that the path length is the Manhattan distance. For example, FIG. 24 shows an example in which a shared path Pc is set within a partial area B4′ in the path setting block area B4.

As a result, in the examples in FIGS. 4 to 24, for all the sinks Si including the farthest sink Sif, the paths from the clock source So are the shortest and equal in length, and the relatively long shared paths are set.

In FIG. 1, the clock tree designing apparatus 1 is provided with memory 11 to 15 configured to store various sorts of information. A sink and wiring information memory 11 stores information (hereinafter referred to as sink and wiring information) about the clock source So, each sink Si, and the farthest sink Sif provided in a circuit layout for which a clock tree is designed, and about wiring. For example, the sink and wiring information may include information about the positions of the clock source So, each sink Si, the farthest sink Sif, and wiring lines, and information about the unit of the wiring grid. In the present embodiment, it is assumed that the clock source So, each sink Si, and the farthest sink Sif represent pins that constitute input and output terminals for the clock. It is also assumed that the pin size and the wiring-line width can be ignored.

A processing order information memory 12 stores information (processing order information) that sequentially indicates in which order the sinks Si are taken as the target sink Sit. The examples in FIGS. 4 to 24 are only illustrative, and different orders of the target sink Sit result in differently designed clock trees. The present embodiment is described on the assumption that the processing order is predetermined, so that the processing order information is read to sequentially perform the processing in the predetermined processing order.

The processing order significantly affects the clock tree generation. It is expected that the determination of the processing order requires many processes. Therefore, for example, several processing orders may be predetermined, and an optimum clock tree may be selected from resultant clock trees generated according to the above-described technique in FIGS. 4 to 24.

In this regard, to set longer shared paths, sinks outside the path setting block area defined by the rectangle with diagonal vertexes located at the clock source So and the farthest sink Sif are preferably processed earlier than inside sinks.

A control section (as a control module) 10 controls writing to and reading from the memory 11 to 15 and controls each section to design a clock tree.

A path setting block setting section (as a path setting block setting module) 21 receives the sink and wiring information from the memory 11 through the control section 10 to set the path setting block area and to output path setting block area information. The path setting block area information is provided to a path setting block area information memory 13 through the control section 10. The path setting block area information memory 13 stores information about each path setting block area between two points.

A branch point information memory 14 stores branch point information received from a branch point setting section (as a branch point setting module) 24 (to be described below) through the control section 10. The path setting block setting section 21, which also receives the branch point information through the control section 10, sets the path setting block area between the clock source So and each branch point to be output and stored as the path setting block area information.

The control section 10 can provide the sink and wiring information about the farthest sink Sif and the target sink Sit from the sink and wiring information memory 11 to a Manhattan distance calculation section 22 according to the processing order information from the processing order information memory 12. The Manhattan distance calculation section 22 calculates the Manhattan distances between two points designated by the control section 10. The result of the calculation of the Manhattan distance calculation section 22 is provided to an equidistant point set calculation section (as an equidistant point set calculation module) 23 through the control section 10. The equidistant point set calculation section 23 determines a set of equidistant points with equal Manhattan distances from the two points. The set of equidistant points may not exactly be on a wiring line. Therefore, the equidistant point set calculation section 23 uses the wiring information to determine a corrected equidistant point set such that the equidistant points are corrected to be on the closest wiring line, for example.

The branch point setting section 24 receives the equidistant point set information, the path setting block area information, and the sink and wiring information through the control section 10 and determines a branch point farthest from the clock source So within each path setting block area. Information about the branch point that is set by the branch point setting section 24 is provided to and stored in the branch point information memory 14 as the branch point information.

A path setting section (as a path setting module) 25 receives the sink and wiring information, the branch point information, and the path setting block area information and sets paths from each branch point to the target sink Sit and to the farthest sink Sif, and a path from the source So to the branch point. Information about the clock paths that are set by the path setting section 25 is provided to a path setting information memory 15. In this manner, the path setting information about the clock tree designed through the clock tree design is stored in the path setting information memory 15.

The clock tree designing apparatus in FIG. 1 can be implemented by a computer that includes a CPU, memory, and input/output devices.

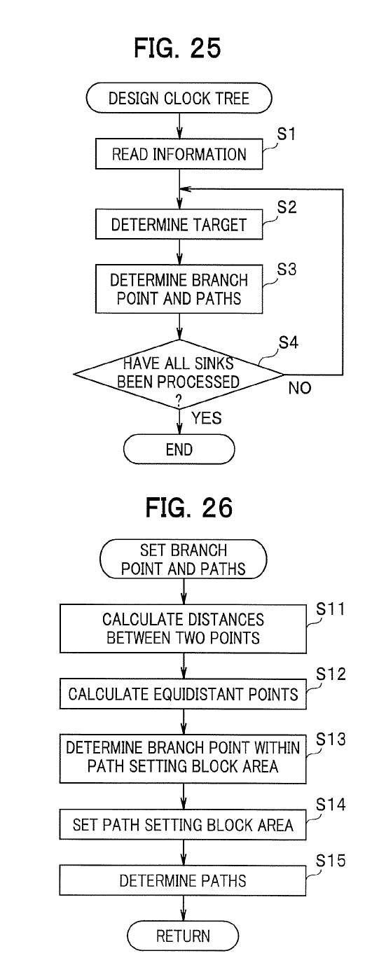

Now, operation in the present embodiment configured as above will be described with reference to FIGS. 25 and 26. FIG. 25 is a flowchart showing the overall operation of designing a clock tree, and FIG. 26 is a flowchart showing a flow of setting a branch point and paths in FIG. 25.

In step S1 in FIG. 25, the control section 10 reads the sink and wiring information and the processing order information from the memory 11 and 12. In step S2, the control section 10 determines the target sink Sit based on the processing order information. The control section 10 then controls each section to determine the branch point of the shared path for the farthest sink Sif and the target sink Sit and determine the paths from the branch point to the farthest sink Sif and to the target sink Sit (step S3).

In step S4, the control section 10 determines whether or not the path determination has been performed for all the sinks Si. If not, the process returns to step S2 to repeat the processing of setting the branch point and the paths.

In order to determine the branch point, in step S11 in FIG. 26, the control section 10 causes the Manhattan distance calculation section 22 to calculate the Manhattan distances between the farthest sink Sif and the target sink Sit. The equidistant point set calculation section 23 calculates the trace of equidistant points under the control of the control section 10 (step S12).

The branch point setting section 24 sets, as the branch point, an equidistant point farthest from the clock source So within the path setting block area (step S13). It is to be noted that, in the processing for the first target sink Sit, the rectangle with diagonal vertexes located at the clock source So and the farthest sink Sif is set as the path setting block area by the path setting block setting section 21.

Through the processing in step S13, for example, the branch points T1 to T3 are determined for the respective pairs of the farthest sink Sif and the target sink Sif in FIGS. 8, 19, and 22.

In next step S14, a rectangle with diagonal vertexes located at the clock source So and the branch point determined in step S13 is set as a new path setting block area by the path setting block setting section 21.

In step S15, the path setting section 25 determines the paths from the branch point determined in step S13 to the farthest sink Sif and to the target sink Sit.

Once the paths from the branch points to all the target sinks Sit are determined, the path setting section 25 finally determines the path from the clock source So to the last determined branch point.

It is to be noted that, if the processing of determining a next branch point does not need to be performed, the processing of setting the path setting block area in step S14 is not needed.

Thus, in the present embodiment, under the condition of minimizing the clock latency, a branch point is determined as a point farthest from the clock source among equidistant points between the farthest sink and the target sink, and paths that pass through the branch point are determined The portion from the clock source to the branch point is a shared path, so that the length of the shared path can be increased. Also, the path lengths of the paths from the branch point are equal. Therefore, the longer shared path and the equal path lengths to the sinks can be realized while minimizing the latency. Thus, while the clock latency can be minimized, the path length of the shared path can be maximized, so that the clock skew and the number of buffers can be minimized Since the lengths of the wiring lines of the paths can be equal, the increase of the skew with respect to variations can be restricted.

### Second Embodiment

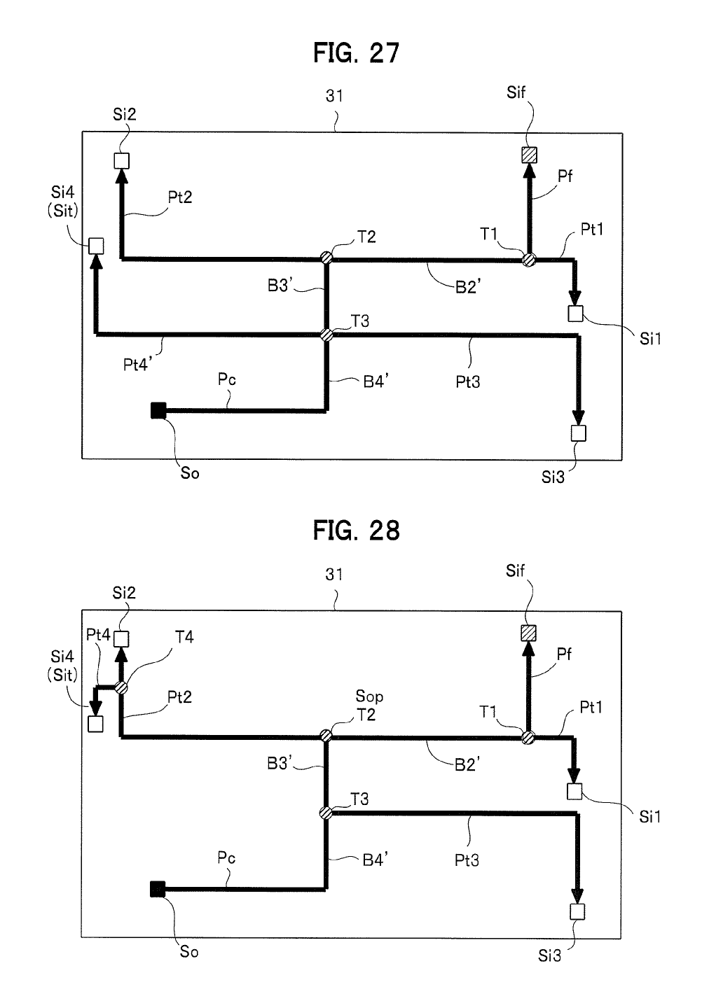

FIGS. 27 and 28 are illustrative diagrams showing a second embodiment of the present invention. The hardware configuration in the present embodiment is the same as the first embodiment. The present embodiment differs from the first embodiment only in the way of determining the branch point and the paths.

FIG. 27 shows an example in which another sink Si4 exists in addition to the three sinks (Si1 to Si3) on the circuit layout in FIG. 24. The sink Si4 is placed in the neighborhood of the sink Si2. The example in FIG. 27 illustrates that the sink Si4 has been set as the target sink Sit, and the branch point and the paths for the target sink Sit have been determined through the technique described in the first embodiment. In the example in FIG. 27, the clock is supplied to the target sink Si4 from the clock source So via the path Pc, the branch point T3, and a path Pt4′.

That is, in the first embodiment, the farthest sink Sif and the target sink Sit are considered as a pair of sinks to be used for setting the branch point, and the branch point is determined at an equidistant point between the pair of sinks. However, in the example in FIG. 27, although the sink Si4 is placed in the neighborhood of the sink Si2, the branch point is relatively distant from the sinks Si2 and Si4, so that the shared path is relatively short.

Therefore in the present embodiment, an arbitrary sink for which the path has been determined is set as a sink (hereinafter referred to as a pair sink) to be used with the target sink Sit for determining the branch point. Further, one of the branch points is simulatively set as a clock source (hereinafter referred to as a pseudo-clock source) instead of the clock source So. In this manner, a branch point that provides a longer shared path is determined.

The path that connects a sink Si for which the path has been determined according to the first embodiment and the clock source So has the same path length as the path from the clock source So to the farthest sink Sif. Therefore, as the pair sink for which the clock latency is to be matched, a sink for which the path has been determined can be used instead of the farthest sink Sif.

FIG. 28 shows an example of this, in which the sink Si2 in the neighborhood of the target sink Sit, instead of the farthest sink Sif, is set as a pair sink in the pair of sinks for determining the branch point on the path to the target sink Sit. Also, the branch point T2 near the target sink Sit is set as a pseudo-source Sop.

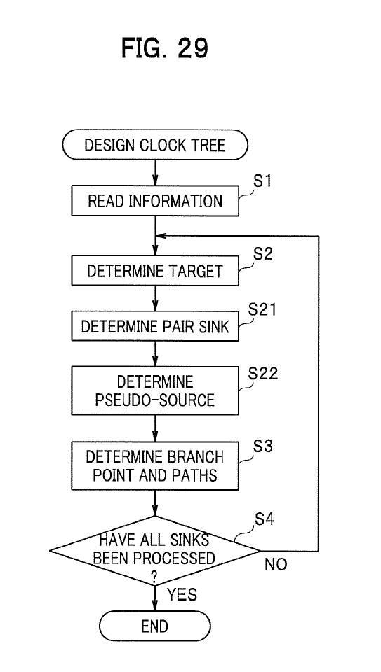

Now, operation in the present embodiment configured as above will be described with reference to a flowchart in FIG. 29. In FIG. 29, the same steps as in FIG. 25 are given the same symbols and will not be described.

The flow in the present embodiment differs from the flow in FIG. 25 only in that processing in steps S21 and S22 is added after step S2. The processing of setting the branch point and the paths is performed according to the flow in FIG. 26 as in the first embodiment.

In the present embodiment, once the target is determined in step S2, the control section 10 determines the pair sink for determining the branch point to the target sink Sit in next step S21. In the first embodiment, the farthest sink Sif is always used. In contrast, in the present embodiment, the control section 10 sets a sink in the neighborhood of the target sink Sit (the sink Si2 in the example in FIG. 28) as the pair sink for determining the branch point.

The control section 10 then determines the pseudo-source Sop that replaces the clock source So. For example, the control section 10 determines a branch point nearest to the target sink Sit (the branch point T2 in FIG. 28) as the pseudo-source Sop.

Subsequent processing is the same as in the first embodiment. That is, the Manhattan distances between the pair sink Si2 and the target sink Sit is determined in S11 in FIG. 26, and the trace of points with equal Manhattan distances is determined (step S12).

Next, in step S13, within a path setting block area given as a rectangle with diagonal vertexes located at the pseudo-source Sop (the branch point T2) and the pair sink Si2, an equidistance point farthest from the pseudo-source Sop is set as the branch point (a branch point T4 in FIG. 28). Then a path Pt4 from the branch point T4 to the target sink Sit is determined so that the path length is the Manhattan distance.

It is to be noted that, if the processing of determining a next branch point does not need to be performed, the processing of setting the path setting block area in step S14 is not needed.

As apparent from comparison between FIGS. 27 and 28, in the present embodiment, the path length of the shared path is increased compared to the first embodiment.

Thus, in the present embodiment, the pair sink for determining the branch point is determined with respect to the position of the target sink. Also, as a vertex of the path setting block area for determining the branch point, the pseudo-source at a branch point is used instead of the clock source. In this manner, the path length of the shared path can be advantageously increased.

The functions of the clock tree designing apparatus in the above embodiments can be realized by implementing the control section with a CPU and causing the CPU to execute a software program. For example, a computer-executed software program can be used to realize the setting of the path setting block areas, the calculation of the Manhattan distances, the calculation of the equidistant point set, and the setting of the branch point and the paths.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A clock circuit tree designing apparatus comprising:
an equidistant point set calculation module configured to determine a set of equidistant points, wherein the Manhattan distance from each of the equidistant points to a plurality of target sinks for which clock latency is to be matched, is the same as the Manhattan distance from each of the equidistant points to a farthest sink of the plurality of target sinks;
a path setting block setting module configured to set a path setting block area, the path setting block area configured to receive a clock path, a path length of the clock path comprising a shortest Manhattan distance from the farthest sink to a clock source;
a branch point setting module configured to set a point in the set of equidistant points as a branch point, where the branch point is farthest of all the equidistant points from the clock source within the path setting block area; and
a path setting module configured to:
set a shared path from the clock source to the branch point;
set a clock path from the branch point to the target sink; and
set a clock path from the branch point to the farthest sink,
so that the path length from the farthest sink to a clock source takes a shortest Manhattan distance.

2. The clock circuit tree designing apparatus of claim 1, further comprising:
a control module configured to:
receive processing order information for sequentially selecting a target sink from the plurality of target sinks and,
control, based on the processing order information, the equidistant point set calculation module, the path setting block setting module, the branch point setting module, and the path setting module to sequentially determine a clock path from the clock source to each sink in the group of sinks for which clock latency is to be matched.

3. The clock circuit tree designing apparatus of claim 1, wherein
the equidistant point set calculation module is configured to determine the set of equidistant points based on information about the clock source and each sink, and wiring information.

4. The clock circuit tree designing apparatus of claim 2, wherein
the equidistant point set calculation module is configured to determine the set of equidistant points based on information about the clock source and each sink, and wiring information.

5. The clock circuit tree designing apparatus of claim 1, wherein
the equidistant point set calculation module is configured to:
determine a midpoint between the clock source and the target sink on a wiring grid,
determine temporary midpoints on the wiring grid by changing a position of the midpoint on a point-by-point basis horizontally and vertically, and
determine the equidistant points by setting the temporary midpoints as the equidistant points inside a rectangular area with diagonal vertexes located at the clock source and the target sink and by extending the temporary midpoints horizontally or vertically outside the rectangular area.

6. The clock circuit tree designing apparatus of claim 2, wherein the equidistant point set calculation module is configured to:
determine a midpoint between the clock source and the target sink on a wiring grid,
determine temporary midpoints on the wiring grid by changing a position of the midpoint on a point-by-point basis horizontally and vertically, and
determine the equidistant points by setting the temporary midpoints as the equidistant points inside a rectangular area with diagonal vertexes located at the clock source and the target sink and by extending the temporary midpoints horizontally or vertically outside the rectangular area.

7. The clock circuit tree designing apparatus of claim 2, wherein
the path setting block setting module is configured to set a rectangular area with diagonal vertexes located at the clock source and the branch point as the path setting block area each time the target sink is shifted to a next sink.

8. The clock circuit tree designing apparatus of claim 2, wherein
the control module is configured to set, as a pair sink, a sink having a clock path already set by the path setting module, and is configured to use the pair sink instead of the farthest sink to control the equidistant point set calculation module, the path setting block setting module, the branch point setting module, and the path setting module.

9. The clock circuit tree designing apparatus of claim 8, wherein
the equidistant point set calculation module is configured to determine the set of equidistant points at which a Manhattan distance from the pair sink instead of the farthest sink and the Manhattan distance from the target sink are equal.

10. The clock circuit tree designing apparatus of claim 8, wherein
the branch point setting module is configured to set, as a branch point of a shared path to the pair sink, a branch point with a shortest Manhattan distance from the pair sink among branch points determined by the branch point setting module.

11. A clock circuit tree designing method implemented on a clock circuit tree designing apparatus, the method comprising:
determining a set of equidistant points, wherein the Manhattan distance from each of the equidistant points to a plurality of target sinks for which clock latency is to be matched, is the same as the Manhattan distance from each of the equidistant points to a farthest sink of the plurality of target sinks;
setting a path setting block area the path setting block area configured to receive a clock path, a path length of the clock path comprising a shortest Manhattan distance from the farthest sink to a clock source;
setting, as a branch point, a point in the set of equidistant points as a branch point, where the branch point is farthest of all the equidistant points from the clock source within the path setting block area; and
setting a shared path from the clock source to the branch point, and setting a clock path from the branch point to the target sink and setting a clock path from the branch point to the farthest sink so that the path length from the farthest sink to the clock source takes a shortest Manhattan distance.

12. The clock circuit tree designing method of claim 11, wherein the steps of:
determining the set of equidistant points;
setting the path setting block area;
setting the branch point; and
setting the clock paths to sequentially determine a clock path from the clock source to each sink in the group of sinks for which clock latency is to be matched;
are performed using a control module and processing order information for sequentially selecting the target sink from the group of sinks for which clock latency is to be matched.

13. The clock circuit tree designing method of claim 11, further comprising:
determining the set of equidistant points based on information about the clock source and each sink, and wiring information.

14. The clock circuit tree designing method of claim 12, further comprising:
determining the set of equidistant points based on information about the clock source and each sink, and wiring information.

15. The clock circuit tree designing method of claim 11, further comprising:
determining a midpoint between the clock source and the target sink on a wiring grid;
determining temporary midpoints on the wiring grid by changing a position of the midpoint on a point-by-point basis horizontally and vertically; and
determining the equidistant points by setting the temporary midpoints as the equidistant points inside a rectangular area with diagonal vertexes located at the clock source and the target sink and by extending the temporary midpoints horizontally or vertically outside the rectangular area.

16. The clock circuit tree designing method of claim 12, further comprising:
determining a midpoint between the clock source and the target sink on a wiring grid;
determining temporary midpoints on the wiring grid by changing a position of the midpoint on a point-by-point basis horizontally and vertically; and
determining the equidistant points by setting the temporary midpoints as the equidistant points inside a rectangular area with diagonal vertexes located at the clock source and the target sink and by extending the temporary midpoints horizontally or vertically outside the rectangular area.

17. The clock circuit tree designing method of claim 12, further comprising:
setting a rectangular area with diagonal vertexes located at the clock source and the branch point as the path setting block area each time the target sink is shifted to a next sink.

18. The clock circuit tree designing method of claim 12, further comprising:
setting, as a pair sink, a sink having a clock path already set, and using the pair sink instead of the farthest sink to determine the set of equidistant points, the path setting block, the branch point, and the clock paths.

19. The clock circuit tree designing method of claim 18, further comprising:
determining the set of equidistant points at which a Manhattan distance from the pair sink instead of the farthest sink and the Manhattan distance from the target sink are equal.

20. The clock circuit tree designing method of claim 18, comprising
setting, as a branch point of a shared path to the pair sink, a branch point with a shortest Manhattan distance from the pair sink among determined branch points.
